(19) United States
(12) Patent Application Publication
(10) Pub. No.: US 2017/0358245 A1
(43) Pub. Date: Dec. 14, 2017

(54) COSMETICS TRAINING REMOVABLE EYE PATCH

(71) Applicant: Mary Jane Dana, Crystal Beach, FL (US)

(72) Inventor: Mary Jane Dana, Crystal Beach, FL (US)

(21) Appl. No.: 15/181,373

(22) Filed: Jun. 13, 2016

(51) Int. Cl. G09B 19/00; G09B 23/30; A45D 44/00

(52) U.S. Cl. CPC G09B 19/0076; A45D 44/00; G09B 23/30

(57) ABSTRACT

The present invention is in the technical field of cosmetology. More specifically, the present invention is utilized in the application of eyelash extensions. The eye patch provides students of cosmetology a practical device to practice and perfect the technique of their craft. Existing training devices do not provide the angle, dimensions or consistency of the eyelid and eyelashes that are necessary for students to apply eyelashes in a manner that is realistic to that of applying an eyelash directly to a human eyelid. The present training aid simulates the human eye in an open or closed state, allowing students to realistically practice performing eyelash extensions without the need of a human subject. Further, the present training aid is removable and reusable.

### BACKGROUND OF THE INVENTION

### Field of the Invention

The present invention relates generally to the field of cosmetics and cosmetology training and practice systems, and, more particularly, to training aids to learn and practice eyelash extension without the need of a human subject.

### Description of Related Art

The cosmetics industry represents a multibillion-dollar enterprise. Individuals willingly spend vast sums of money to change and enhance their appearance. This demand has led to an increase in cosmetology training programs. Accordingly, the demand for improved cosmetology training aids has also increased.

Many patents disclose realistic mannequin heads that have eyes to be used in connection with eyelash extension application training. Additionally, there are patents covering removable or detachable eye features of a mannequin, as well as patents for mannequin heads with eyes that can be displayed in an open or closed state. For example, WIPO Pat. App. No. PCT/GB2009/050768, published on Jan. 7, 2010, describes a mannequin for use in cosmetology training having artificial eyelids that are attached and have a means to open and close the upper eyelids; U.S. Pat. No. 5,090,910 issued on Feb. 25, 1992, discloses a mutable three-dimensional facial display with removable eye components; and U.S. Pat. No. 6,109,921 issued on Aug. 29, 2000, describes a soft skin mannequin head that is capable of forming multiple eye or eyebrow constructions.

As the eyes are one of the human body's most sensitive regions, it is critical that cosmeticians practicing eyelash extensions are properly trained with realistic representations of the eyelid. Without realistic training aids, these professionals are unable to learn to consistently perform eyelash extensions in a clinically safe and reliable manner. Most mannequin heads used in cosmetics training do not present a realistic representation of the dimensions of the human eye. Specifically, the dimensions and margins of the eye are not accurately portrayed on mannequin heads. Additionally, none of the prior art provides for a removable and reusable eyelid patch capable of simulating the human eye in an open or closed state. Furthermore, none of the prior art discloses a cosmetics training device for eyelash extensions that accounts for and simulates the imperfections and inconsistencies inherent in real human eyelashes.

### SUMMARY OF THE INVENTION

The present disclosure attempts to address the problems in the prior art by articulating a device to be used in cosmetology training for performing eyelash extensions without the need of a human subject.

This application describes an eye patch that replicates the most common size and shape of the human eye comprising top and bottom eye shaped lids with a plurality of artificial eyelashes embedded into each of the lids. The eye patch is optionally a single piece capable of folding to create the top and bottom eye shaped lids. Alternatively, the eye patch may be two separate pieces simulating top and bottom eye shaped lids. The eye patch material is preferably porous, absorbent, and flexible to replicate the naturally occurring properties of a human eyelid. The flexibility further permits a user to manipulate the eye patch to change the angle of the lash line, mimicking natural eyelid movement. In the preferred embodiment, the eye patch is removable and has a double-sided, easy-to-remove tape to allow for repeated adhering to a mannequin head or other surface. The preferred embodiment also contains a partial set of color-contrasting lashes to facilitate the practicing of eyelash placement. This allows users to distinguish between the partial set of lashes and artificial eyelash extensions later applied.

In its closed state, the eye patch lids are secured together with adhesive allowing the user to practice performing eyelash extensions on the top lid. The securing mechanism is a double-sided, non-permanent, pressure-sensitive adhesive that is shaped to conform to the perimeter of the eyelid and is used along the base of the lash line. In the closed state, the user can practice performing eyelash extensions on the top lid and the lower lash line. In the open state, the user can practice covering and protecting the lower lash line with surgical tape or other appropriate materials. Given the flexibility of the porous foam material, the eye patch allows the user to check the accuracy of their performance. When open, the eye patch further permits the user to practice performing eyelash extensions on the bottom lid. In the preferred embodiment, the eye patch is a light flesh/skin color. This light color allows the user to check that they are using the correct amount of eyelash adhesive, which is black in color and contrasts with the eye patch.

### BRIEF DESCRIPTION OF THE DRAWINGS

FIG. 1 is a top view of the top lid of the removable eye patch in a closed position.

FIG. 2 is a bottom view of the bottom lid of the removable eye patch in a closed position.

FIG. 3 is a top view of a single body design of the removable eye patch in an open position.

FIG. 4 is a top view of a two-body design of the removable eye patch in an open position.

FIG. 5 is a side perspective view of the side of the removable eye patch in a closed position.

FIG. 6 is a side view of a single body design of the removable eye patch in a closed position.

FIG. 7 is a side view of a two-body design of the removable eye patch.

### DETAILED DESCRIPTION OF THE DRAWINGS

A preferred embodiment of the present invention will be described herein below with reference to the accompanying drawings. While the following written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the below described embodiment, method, and examples, but by all embodiments and methods within the scope and spirit of the invention.

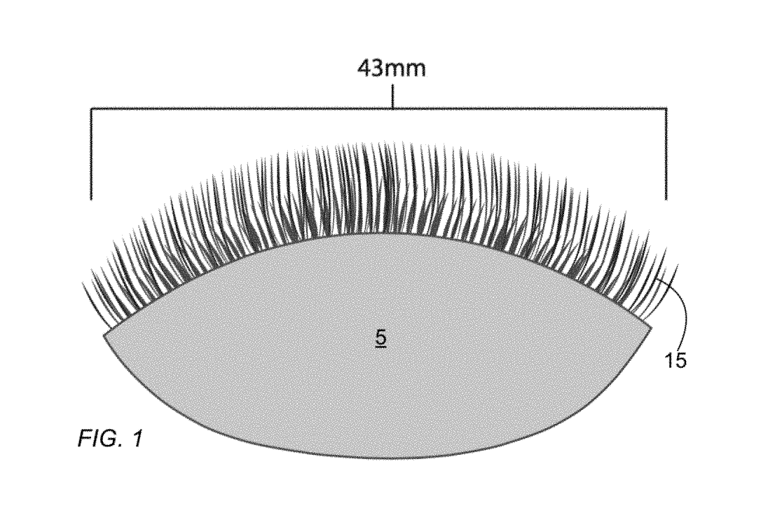

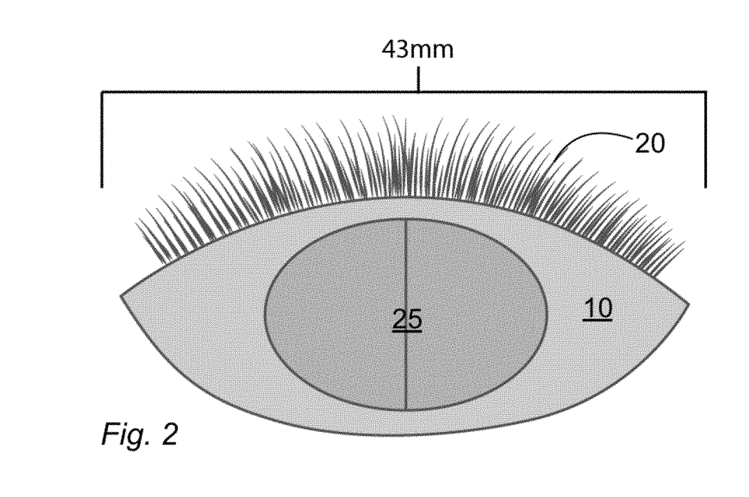

Referring now to FIGS. 1 and 2, the preferred embodiment discloses a removable eye patch with a top lid 5 and a bottom lid 10. The width of the present embodiment is approximately 40 mm. The top and bottom lids of the preferred embodiment, 5 and 10 respectively, are preferably constructed of a flexible foam material such as hydrophilic polyurethane foam that is of a light nude hue. The top lid 5 has a plurality of artificial eyelashes 15 that approximate the size and shape of eyelashes that grow on a human eyelid and are embedded into the foam lid. The bottom lid 10 also has a plurality of artificial eyelashes 20 that approximate the size and shape of eyelashes that grow on a human eyelid and are embedded into the lid. In the preferred embodiment, artificial eyelashes 15 and 20 contrast with the color of the lids 5 and 10 as well as with the artificial eyelash extensions that may be secured thereto.

Still referring to FIGS. 1 and 2, the present embodiment depicts the top and bottom artificial eyelashes, 15 and 20 respectively, as being perfectly consistent in shape and length. However, in other embodiments, the embedded artificial eyelashes may be imperfect, having some or all of the following characteristics: curly, straight, coarse, and/or resilient. This allows the user to practice applying the artificial eyelashes under more realistic circumstances. It should be noted, however, that the top and bottom artificial eyelashes, 15 and 20, are sufficiently separated to allow the user to apply artificial lashes in vacant eyelid spaces.

FIG. 2 is a bottom perspective view of the removable eye patch in its closed position. FIG. 2 demonstrates a preferred embodiment with an adhesive strip 25 pre-attached to the bottom lid 10. The adhesive strip 25 allows the removable eye patch to be adhered to any mannequin head or other surface and need not be pre-attached to the bottom lid 10. In the preferred embodiment, the adhesive strip 25 is made of double-sided, pressure-sensitive silicone-based tape and allows for repeated use. However, one skilled in the art will understand other types of adhesive are capable of securing the bottom lid 10 to the mannequin head or other surface. For example, in other embodiments, a hook and loop fastener may be used as the adhesive strip 25.

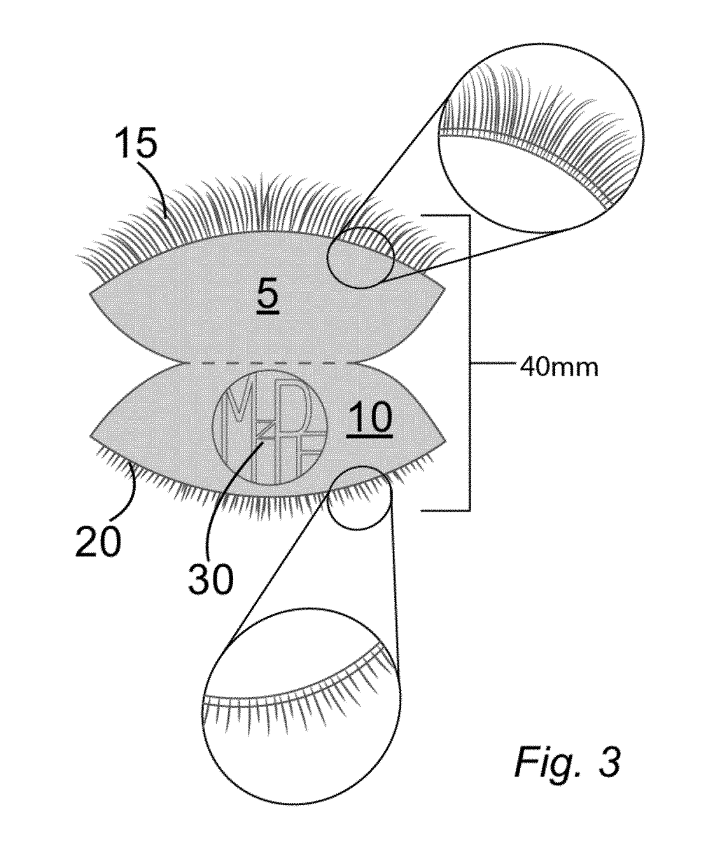

FIG. 3 is a top perspective view of a single body design of the removable eye patch in its open state. In the preferred embodiment, in its open state, the length of the removable eye patch is 30 mm. The top lid 5 is held to the bottom lid 10 by an adhesive 30, which is optionally pre-attached. While the adhesive 30 is preferably double-sided, pressure-sensitive silicone-based tape, one skilled in the art will recognize multiple types of adhesive are suitable for securing the top lid 5 to the bottom lid 10. In an embodiment where the removable eye patch is a single piece, the removable eye patch folds along a middle joining point 35 of the top lid 5 and the bottom lid 10.

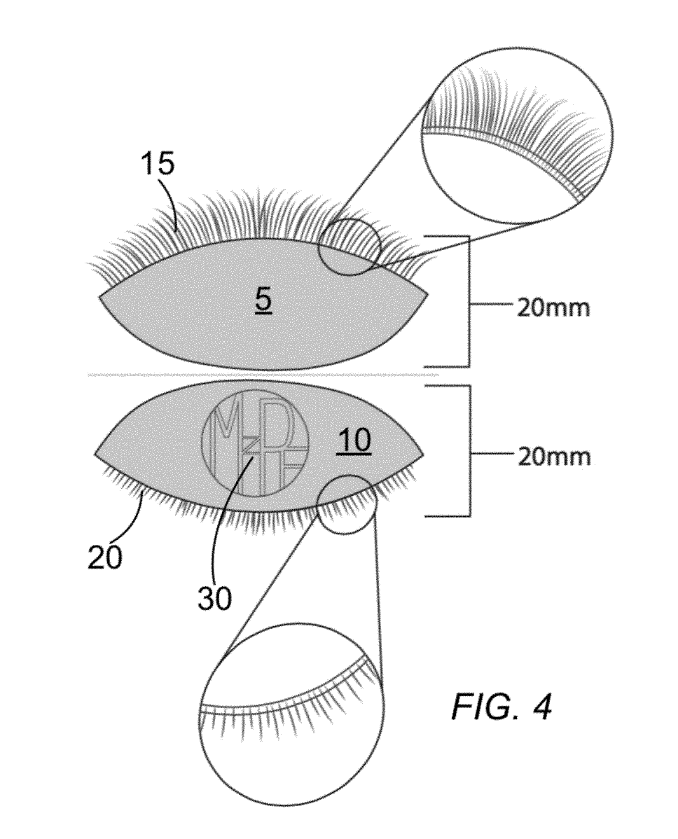

FIG. 4 is a top perspective view of the removable eye patch in its open state. The present embodiment depicts the top lid 5 and the bottom lid 10 as being two distinct pieces. In the preferred embodiment, in its open state, the length of the top lid 5 is 20 mm and the length of the bottom lid 10 is 20 mm. The top lid 5 and the bottom lid 10 optionally adhere together through the use of the adhesive 30.

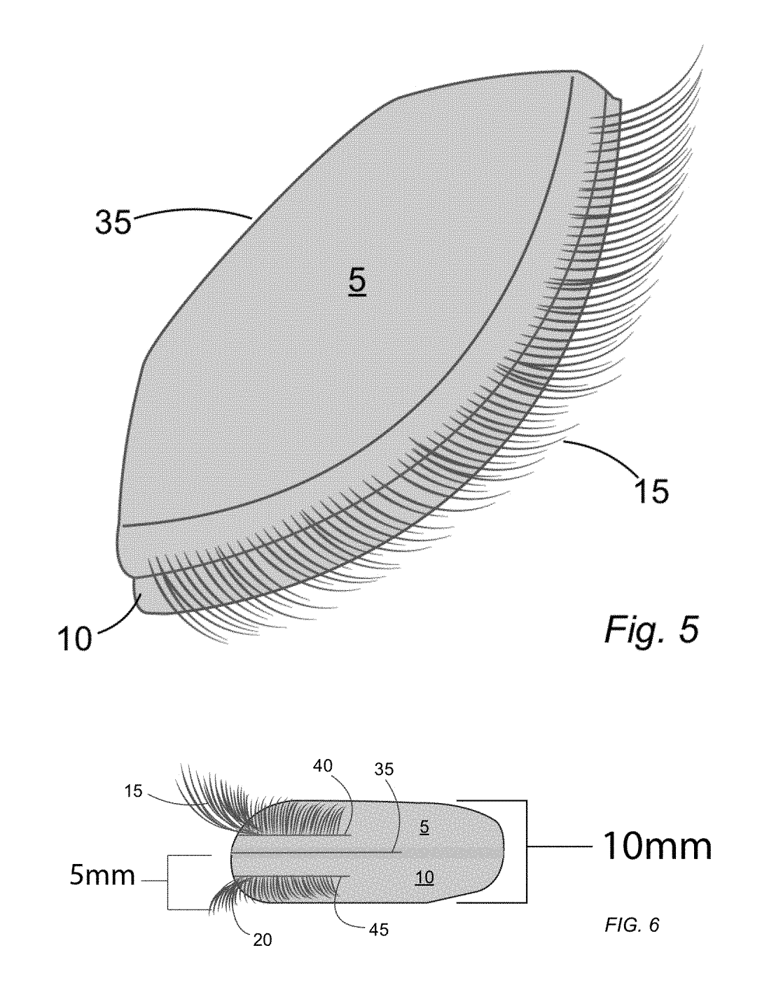

FIG. 5 is a side perspective view of the removable eye patch in its closed state with the top lid 5 and the bottom lid 10 aligned and adhered together. In the preferred embodiment, the embedded top and bottom artificial eyelashes, 15 and 20 respectively, will mimic a natural human eye in its closed state.

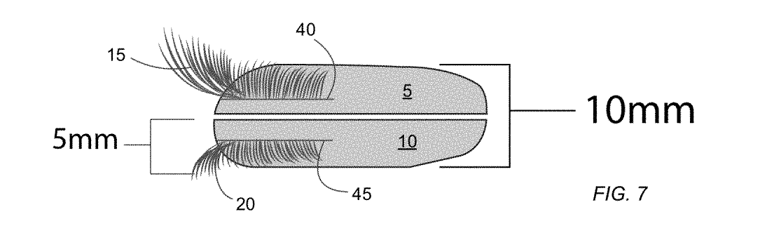

Referring now to FIGS. 6 and 7, FIG. 6 is a side perspective view of a single body design of the removable eye patch in its closed state with the top lid 5 and bottom lid 10 aligned and adhered together. FIG. 7 is a side perspective view of the removable eyepatch wherein the top lid 5 and the bottom lid 10 are two separate pieces. In the preferred embodiment, the plurality of the top artificial eyelashes 15 are embedded into the top lid 5 through measured incisions 40, and the plurality of the bottom artificial eyelashes 20 are embedded into the bottom lid 10 through measured incisions 45. In the preferred embodiment, the incisions 40 and 45 of the top lid 5 and the bottom lid 10, respectively, are 38 mm long and 1 mm wide.

1. A cosmetics training aid comprising
At least one eye patch made of flexible, moldable foam, or similarly sufficient material and having the size and shape approximate to that of a human eyelid.

2. The training aid according to claim 1 in which the eye patches have an adhesive backing and are adherent and selectively removable from any surface.

3. The eye patches according to claim 2 in which the adhesive backing is separately attachable to the eye patches.

4. The training aid according to claim 1 wherein the eye patch is a single piece.

5. The training aid according to claim 4 in which said eye patches are capable of being folded in half and adhering together approximating both closed human eyelids and open human eyelids.

6. The training aid according to claim 1 wherein the eye patch is comprised of two separate eyelids.

7. The training aid according to claim 6 wherein the two separate eyelids are capable of aligning and adhering together approximating both closed human eyelids and open human eyelids.

8. The training aid according to claim 1 in which said eye patches have a plurality of artificial eyelashes embedded into a section of the top and bottom lids.

9. The training aid according to claim 8 in which individual artificial eyelash extensions can be adhered to lash-less sections of the eyelid.

10. The training aid according to claim 8 in which said eyelashes are arranged in a manner so as to approximate the natural growth of human eyelashes on a human eyelid.

11. The training aid according to claim 9 in which individual artificial eyelash extensions can be adhered to the embedded eyelashes of the eye patch.
